(19) United States
(12) Patent Application Publication
(10) Pub. No.: US 2023/0356995 A1
(43) Pub. Date: Nov. 9, 2023

(54) METHOD AND APPARATUS FOR REFUELING AN AIRCRAFT

(71) Applicant: The Boeing Company, Chicago, IL (US)

(72) Inventor: Daniel F. Dahl, Odense (DK)

(21) Appl. No.: 17/738,545

(22) Filed: May 6, 2022

(51) Int. Cl. G06Q 50/06; B67D 7/08; F17C 5/06; G06Q 50/30

(52) U.S. Cl. CPC B67D 7/08; F17C 5/06; G06Q 50/06; G06Q 50/30; F17C 2250/032; F17C 2265/065

(57) ABSTRACT

A method of refueling an aircraft for a trip that includes multiple flight segments separated by stops at airports with refueling options. The method includes predicting a total cost of fuel for the trip for different refueling scenarios in which different numbers of units of fuel are added to the aircraft at respective ones of the airports in the trip. Once predictions of the total cost for each of the refueling scenarios is performed, the refueling scenario with the lowest total cost is selected and a refueling report that indicates the different numbers of units of fuel to add to the aircraft at the respective ones of the airports for the refueling scenario with the lowest total cost is output. An associated apparatus and computer-readable storage medium having computer-readable program code stored therein are also disclosed.

### TECHNOLOGICAL FIELD

The present disclosure relates generally to refueling an aircraft and, in particular, to refueling an aircraft based on a prediction of the cost of refueling the aircraft at various levels and various locations.

### BACKGROUND

Fuel costs are a major part of airline budgets and determining the most efficient way of refueling an aircraft on a trip with multiple stops has been a very tedious, processor intensive, and time consuming endeavor. The issue of predicting total fuel costs for a trip becomes even more complex when airlines want to add more fuel than is necessary to complete their next segment of the trip. For trips with several segments, where the aircraft will land at an airport, potentially refuel, and then take off for the next airport in their trip, the number of calculations needed to be performed to determine a total cost of the trip grows substantially for every segment added. Additionally, taking into account weather and other factors increases the complexity of the calculations even more.

It would therefore be desirable to have a system and method that takes into account at least some of the issues discussed above, as well as other possible issues.

### BRIEF SUMMARY

Example implementations of the present disclosure are directed to refueling an aircraft for a trip that includes multiple flight segments separated by stops at airports with fueling operations. Example implementations include a method where a total cost of fuel for a trip of an aircraft is predicted, based on many possible refueling scenarios at several different airports in a trip, and the refueling scenario with the lowest total cost is selected. The aircraft can then be refueled according to a refueling report that indicates a different number of units of fuel to add to the aircraft at respective ones of the several airports in the trip.

The present disclosure thus includes, without limitation, the following example implementations.

Some example implementations provide an apparatus for refueling an aircraft for a trip that includes multiple flight segments separated by stops at airports with fueling operations, the apparatus comprising: a memory configured to store computer-readable program code; and processing circuitry configured to access the memory, and execute the computer-readable program code to cause the apparatus to at least: access information that indicates cost per unit of fuel at respective ones of the airports; predict a total cost of fuel for the trip for different refueling scenarios in which different numbers of units of fuel are added to the aircraft at the respective ones of the airports, the apparatus caused to predict the total cost includes the apparatus caused to predict a cost of adding a number of units at an airport of the airports, and the apparatus caused to predict the cost of adding the number of units at the airport includes the apparatus caused to at least: predict a number of units consumed during travel from the airport to a next one of the airports, the number of units consumed predicted as a function of a total number of units onboard the aircraft on takeoff from the airport; determine a number of units needed to raise a starting number of units to the number of units consumed; determine any extra units added above the number of units needed; and predict the cost of adding the number of units needed and the extra units added, based on the cost per unit of fuel at the airport; select one of the different refueling scenarios with a lowest total cost; and output a refueling report that indicates the different numbers of units of fuel to add to the aircraft at the respective ones of the airports for the one of the different refueling scenarios.

Some example implementations provide a method of refueling an aircraft for a trip that includes multiple flight segments separated by stops at airports with fueling operations, the method comprising: accessing information that indicates cost per unit of fuel at respective ones of the airports; predicting a total cost of fuel for the trip for different refueling scenarios in which different numbers of units of fuel are added to the aircraft at the respective ones of the airports, predicting the total cost includes predicting a cost of adding a number of units at an airport of the airports, and predicting the cost of adding the number of units at the airport includes: predicting a number of units consumed during travel from the airport to a next one of the airports, the number of units consumed predicted as a function of a total number of units onboard the aircraft on takeoff from the airport; determining a number of units needed to raise a starting number of units to the number of units consumed; determining any extra units added above the number of units needed; and predicting the cost of adding the number of units needed and the extra units added, based on the cost per unit of fuel at the airport; selecting one of the different refueling scenarios with a lowest total cost; and outputting a refueling report that indicates the different numbers of units of fuel to add to the aircraft at the respective ones of the airports for the one of the different refueling scenarios.

Some example implementations provide a computer-readable storage medium for refueling an aircraft for a trip that includes multiple flight segments separated by stops at airports with fueling operations, the computer-readable storage medium being non-transitory and having computer-readable program code stored therein that, in response to execution by processing circuitry, causes an apparatus to at least: access information that indicates cost per unit of fuel at respective ones of the airports; predict a total cost of fuel for the trip for different refueling scenarios in which different numbers of units of fuel are added to the aircraft at the respective ones of the airports, the apparatus caused to predict the total cost includes the apparatus caused to predict a cost of adding a number of units at an airport of the airports, and the apparatus caused to predict the cost of adding the number of units at the airport includes the apparatus caused to at least: predict a number of units consumed during travel from the airport to a next one of the airports, the number of units consumed predicted as a function of a total number of units onboard the aircraft on takeoff from the airport; determine a number of units needed to raise a starting number of units to the number of units consumed; determine any extra units added above the number of units needed; and predict the cost of adding the number of units needed and the extra units added, based on the cost per unit of fuel at the airport; select one of the different refueling scenarios with a lowest total cost; and output a refueling report that indicates the different numbers of units of fuel to add to the aircraft at the respective ones of the airports for the one of the different refueling scenarios.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates one type of vehicle, namely, an aircraft that can benefit from example implementations of the present disclosure;

FIG. 2 illustrates an aircraft manufacturing and service method, according to some example implementations;

FIG. 3 illustrates a scenario of an example trip of an aircraft including multiple stops at different airports, according to some example implementations;

FIG. 4 illustrates a system for refueling an aircraft for a trip, according to some example implementations;

FIG. 5 is a table illustrating an example implementation of the calculations performed in a method of refueling an aircraft, according to some example implementations;

FIGS. 6A, 6B, 6C, 6D, and 6E are a flowchart illustrating various steps in a method of refueling an aircraft for a trip, according to some example implementations; and

FIG. 7 illustrates an apparatus for use in refueling an aircraft for a trip according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure can be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) can instead be below, and vice versa; and similarly, features described as being to the left of another feature else can instead be to the right, and vice versa. Also, while reference can be made herein to quantitative measures, values, geometric relationships or the like, unless otherwise stated, any one or more if not all of these can be absolute or approximate to account for acceptable variations that can occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms can be at times used interchangeably.

Example implementations of the present disclosure relate generally to vehicular engineering and, in particular, to one or more of the design, construction, operation or use of vehicles. As used herein, a vehicle is a machine designed as an instrument of conveyance by land, water or air. A vehicle designed and configurable to fly can at times be referred to as an aerial vehicle, an aircraft or the like. Other examples of suitable vehicles include any of a number of different types of ground vehicles (e.g., motor vehicles, railed vehicles), watercraft, amphibious vehicles, spacecraft and the like.

A vehicle generally includes a basic structure, and a propulsion system coupled to the basic structure. The basic structure is the main supporting structure of the vehicle to which other components are attached. The basic structure is the load-bearing framework of the vehicle that structurally supports the vehicle in its construction and function. In various contexts, the basic structure can be referred to as a chassis, an airframe or the like.

The propulsion system includes one or more engines or motors configured to power one or more propulsors to generate propulsive forces that cause the vehicle to move. A propulsor is any of a number of different means of converting power into a propulsive force. Examples of suitable propulsors include rotors, propellers, wheels and the like. In some examples, the propulsion system includes a drivetrain configured to deliver power from the engines / motors to the propulsors. The engines / motors and drivetrain can in some contexts be referred to as the powertrain of the vehicle.

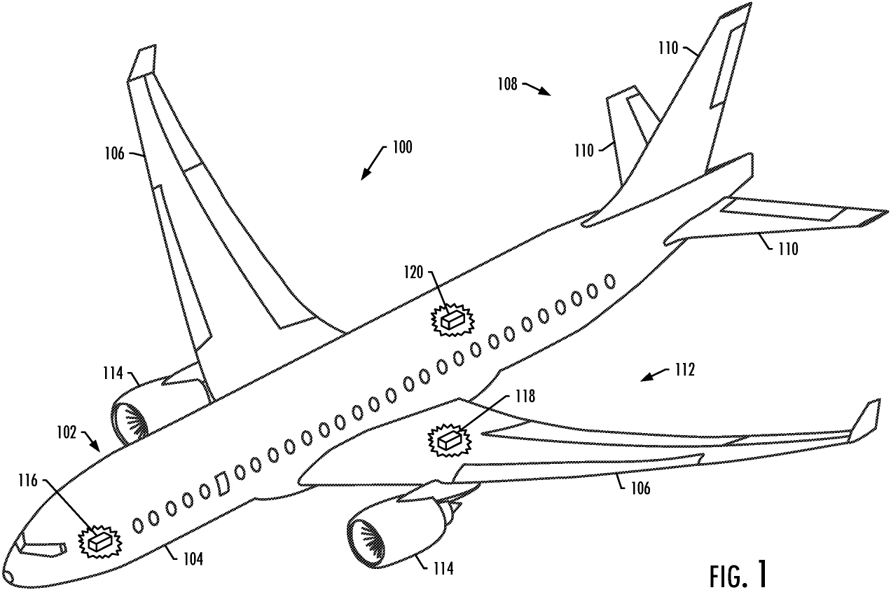

FIG. 1 illustrates one type of vehicle, namely, an aircraft 100 that can benefit from example implementations of the present disclosure. As shown, the aircraft includes a basic structure with an airframe 102 including a fuselage 104. The airframe also includes wings 106 that extend from opposing sides of the fuselage, an empennage or tail assembly 108 at a rear end of the fuselage, and the tail assembly includes stabilizers 110. The aircraft also includes a plurality of high-level systems 112 such as a propulsion system. In the particular example shown in FIG. 1, the propulsion system includes two wing-mounted engines 114 configured to power propulsors to generate propulsive forces that cause the aircraft to move. In other implementations, the propulsion system can include other arrangements, for example, engines carried by other portions of the aircraft including the fuselage and/or the tail. As also shown, the high-level systems can also include an electrical system 116, hydraulic system 118 and/or environmental system 120. Any number of other systems can be included.

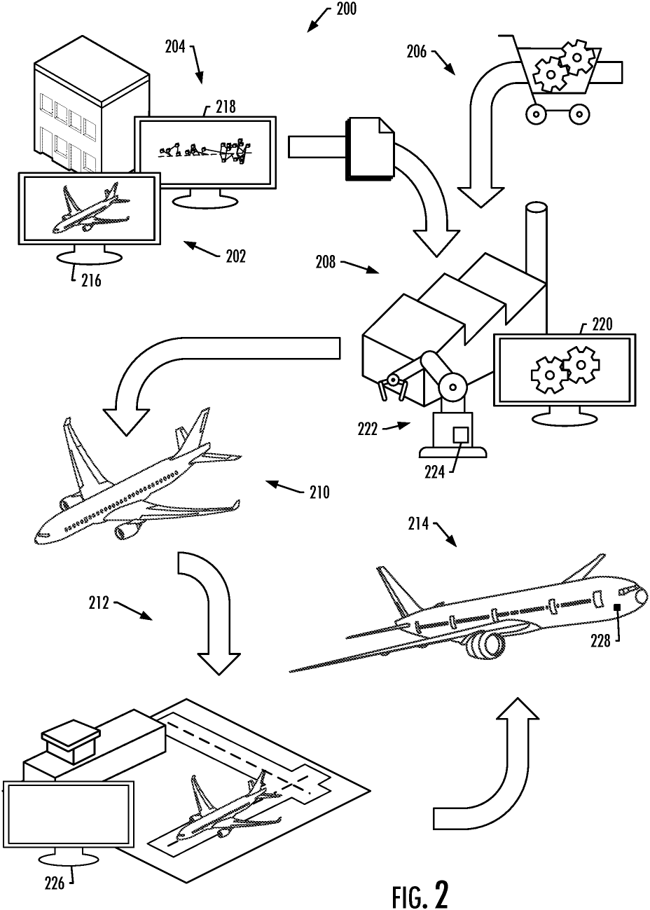

As explained above, example implementations of the present disclosure relate generally to vehicular engineering and, in particular, to one or more of the design, construction, operation or use of vehicles such as aircraft 100. Thus, referring now to FIG. 2, example implementations can be used in the context of an aircraft manufacturing and service method 200. During pre-production, the example method can include specification and design 202 of the aircraft, manufacturing sequence and processing planning 204 and material procurement 206. During production, component and subassembly manufacturing 208 and system integration 210 of the aircraft takes place. Thereafter, the aircraft can go through certification and delivery 212 in order to be placed in service 214. While in service by an operator, the aircraft can be scheduled for maintenance and service (which can also include modification, reconfiguration, refurbishment or the like).

Each of the processes of the example method 200 can be performed or carried out by a system integrator, third party and/or operator (e.g., customer). For the purposes of this description, a system integrator can include for example any number of aircraft manufacturers and major-system subcontractors; a third party can include for example any number of vendors, subcontractors and suppliers; and an operator can include for example an airline, leasing company, military entity, service organization or the like.

As will also be appreciated, computers are often used throughout the method 200; and in this regard, a “computer” is generally a machine that is programmable or programmed to perform functions or operations. The method as shown makes use of a number of example computers. These computers include computers 216, 218 used for the specification and design 202 of the aircraft, and the manufacturing sequence and processing planning 204. The method can also make use of computers 220 during component and subassembly manufacturing 208, which can also make use of computer numerical control (CNC) machines 222 or other robotics that are controlled by computers 224. Even further, computers 226 can be used while the aircraft is in service 214, as well as during maintenance and service; and as suggested in FIG. 1, the aircraft can itself include one or more computers 228 as part of or separate from its electrical system 116.

A number of the computers 216, 218, 220, 224, 226, 228 used in the method 200 can be co-located or directly coupled to one another, or in some examples, various ones of the computers can communicate with one another across one or more computer networks. Further, although shown as part of the method, it should be understood that any one or more of the computers can function or operate separate from the method, without regard to any of the other computers. It should also be understood that the method can include one or more additional or alternative computers than those shown in FIG. 2.

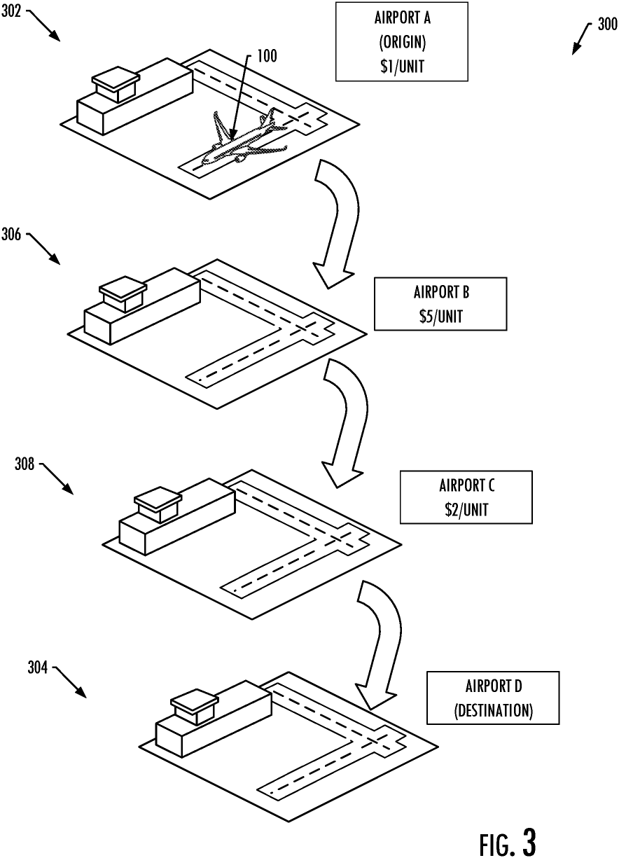

Example implementations of the present disclosure can be implemented throughout the aircraft manufacturing and service method 200, but are particularly well suited for implementation while in service. In this regard, FIG. 3 illustrates a scenario 300 including a trip of the aircraft 100 from an origin Airport A 302 to a destination airport D 304, and that includes multiple flight segments separated by stops at Airport B 306 and Airport C 308 with refueling operations. Although shown with two intermediate stops, it should be understood that example implementations can be equally applicable to trips that include one intermediate stop, as well as trips that include more than two intermediate stops. Each flight from one airport to the next airport in the trip is termed throughout this description as a “segment” of the trip. For example, in the illustration provided in FIG. 3, the flight from Airport A to Airport B is a segment, as is the flight from Airport B to Airport C, etc.

Additionally, illustrated in FIG. 3, in the label for the airport, an example cost per unit of fuel (e.g., pounds, gallons, liters, etc.) is provided. For example, at Airport A 302, the cost per unit of fuel is provided, as $1 / unit. This dollar amount is provided for hypothetical purposes only and should not be read as limiting the application in any way or as indicating any sort of true cost of units of fuel. Similarly, for the purposes of illustration, the cost per unit of fuel at Airport B 306 is $5 / unit and the cost per unit of fuel at Airport C 308 is $2 / unit. Since Airport D 304 is the end of the trip, refueling here will not be taken into account. This illustrative example will be used later herein to help demonstrate the operation of some aspects of the present disclosure. The costs listed are the costs of fuel, per unit, at each of the airports.

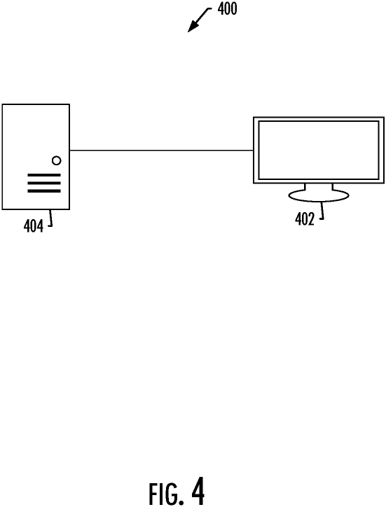

FIG. 4 illustrates a system 400 for refueling an aircraft 100 for a trip such as that described above in the scenario 300, according to some example implementations. As shown in FIG. 4, the system includes a computer 402 that in various examples can correspond to computer 226 or computer 228. In some examples, the computer is configured to access data from one or more data sources 404 configured to provide information that indicates the prices per unit of fuel at airports at which the aircraft might refuel during a trip. Furthermore, the data source can be configured to provide information that indicates a starting number of units of fuel onboard the aircraft at the origin airport (e.g., Airport A 302) before the aircraft has embarked on the trip.

Example implementations of the present disclosure provide the system 400, including the computer 402 for refueling an aircraft 100 for a trip that includes multiple flight segments separated by stops at airports with fueling operations. The computer is configured to access information that indicates cost per unit of fuel at respective ones of the airports. For example, the computer can query the one or more data sources 404, which can be sent the cost per unit of fuel of each of the airports in the trip, such as the costs at each airport shown in FIG. 3. The computer is configured to predict a total cost of fuel for the trip for different refueling scenarios in which different numbers of units of fuel are added to the aircraft at the respective ones of the airports. This includes the computer configured to predict a cost of adding a number of units at an airport of the airports.

For example, in the scenario illustrated in FIG. 3, the computer 402 is configured to predict a cost of adding a number of units of fuel at Airport A, Airport B 306, and Airport C 308. However, the computer would not predict the cost of adding a number of units of fuel at Airport D 304 because it is the final airport in the trip. The computer then determines a total cost of the trip by adding up all the predicted costs for each of Airports A, B, and C.

For each trip, the different refueling scenarios are bounded by the maximum number of units of fuel the aircraft 100 can take onboard and the minimum number of units of fuel the aircraft is allowed by law or other restriction to embark on a certain flight segment. For example, in performing the disclosed method herein, the computer 402 performs the method for different refueling scenarios whereby different amounts of fuel can be added at each airport in the trip based on the maximum and minimim bounds discussed above. That is, in performing the method for a trip, the presently disclosed subject matter, in some example implementations, performs the described predictions and calculations for many permutations of units of fuel added at each airport in the trip. In some other example implementations, there may be only a few permutations performed.

The computer 402 configured to predict the cost of adding the number of units at the airport 100 includes the the computer configured to predict a number of units consumed during travel from the airport to a next one of the airports, the number of units consumed predicted as a function of a total number of units onboard the aircraft on takeoff from the airport. For example, the computer is configured to predict the number of units of fuel that will be consumed traveling from Airport A 302 to Airport B 306, and from Airport B to Airport C 308, etc. The amount of fuel that will be consumed flying the aircraft from Airport A to Airport B is a function of the total number of units of fuel onboard the aircraft on takeoff from Airport A. This is true for the aircraft flying from Airport B to Airport C. As more wieght (i.e., fuel) is added to the aircraft, the aircraft will burn additional fuel to carry the extra weight from one airport to the next.

The computer 402 is configured to determine a number of units needed to raise a starting number of units, which is known by the computer from querying the one or more data sources 404 or the onboard systems of the aircraft, to the number of units consumed. The computer is configured to determine any extra units added above the number of units needed. That is, if 10 units are needed to fly from Airport A to Airport B, but at Airport A, before takeoff, enough units of fuel are added such that the total units of fuel onboard the aircraft 100 is 15 units, the extra fuel is 5. However, as described below, these extra fuel units have a cost: the extra weight actually increases the amount of fuel (trip units) that will be burned on the flight segment. And the computer is configured to predict the cost of adding the number of units needed and the extra units added, based on the cost per unit of fuel at the airport.

The computer 402 is configured to select one of the different refueling scenarios with a lowest total cost. And the computer is configured to output a refueling report that indicates the different numbers of units of fuel to add to the aircraft at the respective ones of the airports for the one of the different refueling scenarios.

In some examples, the trip starts at an origin airport that also has refueling operations, and different numbers of units of fuel are also added to the aircraft at the origin airport in the different refueling scenarios. The computer 402 configured to predict the total cost of fuel for a refueling scenario of the different refueling scenarios includes the computer configured to predict the cost of adding a first number of units of fuel at the origin airport. The computer is configured to predict the cost of adding subsequent numbers of units of fuel at the respective ones of the airports, including the cost of adding the number of units at the airport. And the computer is configured to predict the total cost of fuel as a summation of the cost of adding the first number of units and the subsequent numbers of units.

In some examples, the computer 402 is further configured to access information, for example, from one or more data sources 404, that indicates a first starting number of units of fuel onboard the aircraft 100 at the origin airport. The computer configured to predict the cost of adding the first number of units of fuel includes the computer configured to predict the cost of adding a first number of units needed to raise the first starting number of units to a first number of units consumed during travel from the origin airport to the next one of the airports, and any extra units added above the first number of units needed.

In some examples, the computer 402 configured to predict the cost of adding the first number of units includes the computer configured to predict the first number of units consumed during travel from the origin airport to the next one of the airports, the number of units consumed predicted as a function of the total number of units onboard the aircraft on takeoff from the origin airport. The computer is configured to determine the first number of units needed to raise the first starting number of units to the first number of units consumed. The computer is configured to determine any extra units added above the first number of units needed. And the computer is configured to predict the cost of adding the number of units needed and the extra units added, based on the cost per unit of fuel at the origin airport.

In some examples, the function for prediction of the number of units consumed is a linear function in which a change in the number of units consumed during travel from the airport is directly proportional to a change in the total number of units onboard the aircraft on takeoff from the airport.

In some examples, the function for prediction of the number of units consumed is a function of a weight of the aircraft and a distance from the airport to the next one of the airports, and the weight of the aircraft includes the weight of the total number of units onboard the aircraft, and the weight of any passengers, crew, equipment, luggage and cargo onboard the aircraft on takeoff from the airport.

In some examples, each of the different refueling scenarios includes a different combination of extra units added across the airports.

In some examples, no extra units of fuel are added at one or more of the airports in one or more of the different refueling scenarios.

The disclosed subject matter may be better understood by referring to the following hypothetical. An aircraft embarks on a trip from airport i = 1 (i.e., the origin airport) to airport i = I (i.e., the destination of the trip), wherein the trip includes stops at airports i= 2, 3, ... (I - 1). At each airport, before taking off and before any fuel has been added onboard the aircraft, the aircraft has a starting fuel of Start_{I} at airport i. For example, at the origin airport i=1, the starting fuel Start₁ is given as START.

In order to travel from airport i to airport i + 1, the aircraft will consume/burn a number of units of fuel equal to Tripᵢ. Tripᵢ is a linear function of the total amount of fuel (total amount of weight, technically, but fuel is the biggest variable) onboard the aircraft before takeoff from airport i to airport i + 1. That is, as more units of fuel are added onto the aircraft, more fuel will be consumed/burned in order to make the flight from one airport to the next because of the added weight onboard the aircraft. Before takeoff, and if needed, the aircraft will refuel at each airport if the aircraft has not reached its destination. The amount of fuel added at airport i is Addᵢ and this amount added will increase the amount of fuel onboard the aircraft from Startᵢ to Tripᵢ. Equation (1) below illustrates this calculation:

$$A d {d}_{i} = T r i {p}_{i} - S t a r {t}_{i} \qquad \text{(1)}$$

In some cases, based on the cost / unit of fuel at the different airports in the trip, it is advantageous to add more fuel over Addᵢ. In such cases, the extra fuel added above Addᵢ at airport i is Extraᵢ. The total amount of fuel Totalᵢ onboard the aircraft on takeoff at airport i is given by Equations (2) and (3) below:

$$T o t a {l}_{i} = S t a r {t}_{i} + A d {d}_{i} + E x t r {a}_{i} \qquad \text{(2)}$$

$$T o t a {l}_{i} = T r i {p}_{i} + E x t r {a}_{i} \qquad \text{(3)}$$

In some example implementations the cost (at each airport) per unit of fuel added to the aircraft is equal to Costᵢ. The amount of fuel added at airport i is equal to the amount of fuel added Addᵢ at the airport i plus the extra fuel Extraᵢ added above, or Addᵢ + Extraᵢ. The cost of fuel added at airport i is given by Equation (4) or (5) below:

$$\text{Cost of fuel at} i = \left(T o t a {l}_{i} - S t a r {t}_{i}\right) * C o s {t}_{i} \qquad \text{(4)}$$

$$= \left(\left(T r i {p}_{i} + E x t r a\right) - S t a r {t}_{i}\right) * C o s {t}_{i} \qquad \text{(5)}$$

The total cost for a trip (i.e., the aircraft flying from airport i = 1 to airport i = I) of the aircraft Total Cost is equal to a summation of the cost of fuel added (Addᵢ + Extraᵢ) at each of the airports in the trip. To determine the Total Cost, the trip is split up into sections: a first section including the cost at the origin airport 1 and a second section including the costs at each airport after the origin airport. The cost of fuel added at airport i = 1, where the starting amount of fuel at the origin airport Start₁ is given as START, is given by Equation (6) (derived by Equation (5) above) below:

$$\begin{matrix}\text{Cost of fuel added at airport} i = 1 = \\ \left(\left(T r i {p}_{1} + E x t r {a}_{1}\right) - \text{START}\right) * C o s {t}_{1}\end{matrix} \qquad \text{(6)}$$

The cost of fuel added at airport i > 1, where the starting amount of fuel at each subsequent airport Startᵢ _{>} ₁ is equal to the total amount of fuel onboard the airport at take off at the directly preceding airport Total_{i - 1} minus the amount of fuel consumed/burned by the aircraft to travel from the preceding airport to the current airport where refueling is occurring Tripᵢ₋₁, is given by Equation (7) (also derived by Equation (5) above) below:

$$\begin{matrix}\text{Cost of fuel added at airport} i > 1 = \\ \left(\left(T r i {p}_{i} + E x t r {a}_{i}\right) - \left(T o t a {l}_{i \text{-} 1} - T r i {p}_{i \text{-} 1}\right)\right) * C o s {t}_{i}\end{matrix} \qquad \text{(7)}$$

Once the cost at each airport is determined, the Total Cost is given as Equation (8) or Equation (9) below:

$$\begin{matrix}T o t a l C o s t = \left(T o t a {l}_{1} - \text{START}\right) * C o s {t}_{1} + \\ \sum \left(\left(T o t a {l}_{i} - \left(T o t a {l}_{i \text{-} 1} - T r i {p}_{i \text{-} 1}\right)\right) * C o s {t}_{i}\right)\end{matrix} \qquad \text{(8)}$$

The summation for airports i = 2 to i = I - 1

$$\begin{matrix}T o t a l C o s t = \left(\left(T r i {p}_{1} + E x t r {a}_{1}\right) - S t a r {t}_{1}\right) * C o s {t}_{1} + \\ \sum \left(\left(\left(T r i {p}_{i} + E x t r {a}_{i}\right) - \left(T o t a {l}_{i \text{-} 1} - T r i {p}_{i \text{-} 1}\right)\right) * C o s {t}_{i}\right) \\ \text{The summation for airports} i = 2 \text{to} i = I - 1\end{matrix} \qquad \text{(9)}$$

In some examples in which every refueling scenario is run, the number of calculations that are performed to determine the total cost of fuel for the trip for each refueling scenario can potentially include millions of calculations. That is, millions of potential calculations can be performed for one trip based on the number of units of fuel the aircraft can take onboard the aircraft and the minimum number of units the aircraft will need onboard to make the flight from airport i to airport i + 1.

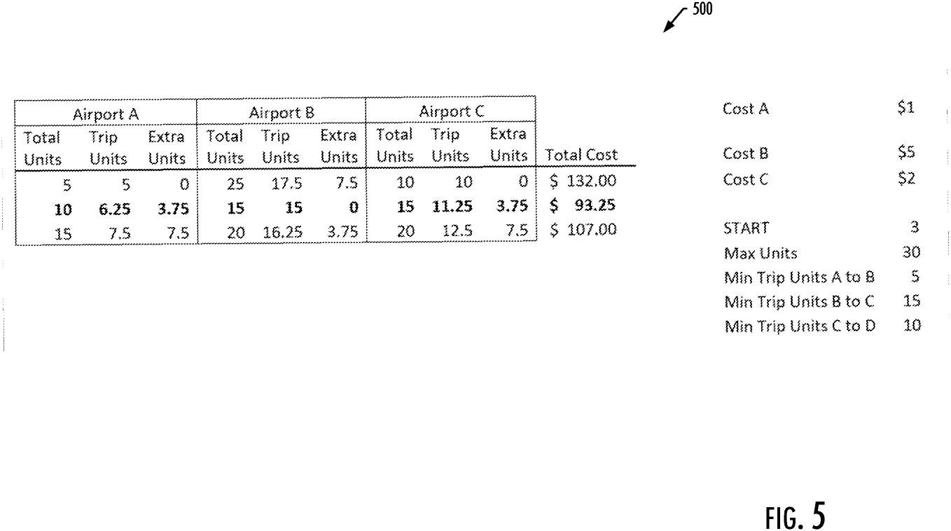

FIG. 5 is a table 500 including three different example refueling scenarios that help illustrate the presently described subject matter. The table is calculated based on the example scenario 300 from FIG. 3, wherein different refueling scenarios at Airport A 302, Airport B 306, and Airport C 308 are analyzed to determine the lowest cost for the trip. The section under the heading “Airport A” is the refueling scenario for the segment from Airport A to Airport B, and the section under the heading “Airport B” is the refueling scenario for the segment from Airport B to Airport C, etc. The subject matter described herein includes determining how many extra units of fuel to add to the aircraft 100 at each airport in the trip to arrive at the lowest cost for the trip. While only three pricing scenarios are presented in the table, the presently disclosed subject matter actually performs potentially thousands of refueling scenarios based on the maximum number of units of fuel the aircraft 100 is capable of holding while still being able to take off and the minimum number of units that the aircraft is required to take onboard (e.g., based on legal or other regulations).

For example, as shown in the Table, the maximum number of units the aircraft can hold is given as 30 units, the minimum units to travel from Airport A 302 to Airport B 306 is 5 units, the minimum units to travel from Airport B to Airport C 308 is 15 units, and the minimum units to travel from Airport C to Airport D 304 is 10 units. A full running of the method described herein would predict the total cost of fuel sweeping from 5 units to 30 units for the segment Airport A to Airport B, 15 units to 30 units for the segment Airport B to Airport C, and 10 units to 30 units for the segment Airport C to Airport D. In this scenario, the method will perform the predictions by sweeping the number of units from the minimum total fuel to the maximum total fuel described above by increasing the number of total units onboard the aircraft 100 for each segment by any suitable increment.

For example, while the Total Units in the Table 500 for the segment going from Airport A 302 to Airport B 306 increase from 5 to 10 to 15, the increments could be 5 to 5.5 to 6 or 5 to 6 to 7, or any suitable increment. The same goes for the other two segments under the “Airport B” and “Airport C” headings. Additionally, every possible (limited by the increments or decrements) permutation of Total Units at each airport is predicted. That is, a plurality of refueling scenarios are calculated whereby the Total Units under “Airport A” is swept from 5 units to 30 units (in this example) in any suitable increment, but during each of these permutations, the Total Units under “Airport B” will remain 25, and the Total Units under “Airport C” will remain 10. Once the calculations are performed from Total Units of 5 units to 30 units under “Airport A”, the Total Units under “Airport B” decrement by 1 (i.e., from 25 to 24) (or any other suitable decrement), the Total Units under “Airport C” remain 10, and the calculations for total fuel cost are run again by sweeping the Total Units under “Airport A” from 5 units to 30 units. These calculations and incrementations/decrementations are calculated until every possible permutation of the Total Units at each airport has been included in a calculation. From there, out of the many total costs calculated, the lowest possible total cost of fuel is determined and selected.

While the Total Units under “Airport A” and “Airport C” are shown as incrementing, the Total Units under “Airport B” are shown as decrementing. This is to illustrate that the presently disclosed method can sweep the values from minimum Trip Units to Max Units by either incrementing the values or decrementing the values of Total Units as long as all of the possible permutations are calculated.

As described herein, the Trip Units of fuel under each of “Airport A”, “Airport B”, and “Airport C” is a function of the number of units of fuel onboard the aircraft 100 and has a minimum bound of the minimum number of units consumed during travel on the segment (e.g., can be set by regulation, law, airline rule, or by physical characteristics of the aircraft and the surrounding environmental characteristics). Also, as described herein, the trip units consumed during a segment is a linear function in which a change in the number of units consumed during travel from the airport is directly proportional to a change in the total number of units onboard the aircraft on takeoff from the airport. Additionally, the number of units consumed during a segment is a function of a weight of the aircraft and a distance from the airport the aircraft is departing from to the next airport of the segment. The weight of the aircraft includes the weight of the total number of units onboard the aircraft, and the weight of any passengers, crew, equipment, luggage, and cargo onboard the aircraft on takeoff from the airport.

In the example table 500, the number of Trip Units for each airport is shown as increasing by 0.25 for each unit of fuel added to the aircraft 100. However, this is for illustrative purposes only. The true increase, again, is a linear function directly proportional to a change in the total number of units onboard the aircraft on takeoff from the airport.

In order to determine the rate (e.g., the 0.25 units in the example given in FIG. 5) at which the number of Trip Units increases for every next unit of fuel added to the aircraft, the computer 402 is configured to perform several calculations. First, the computer is configured to determine the maximum amount of Trip Units for the maximum amount of total fuel allowed on the aircraft in order for it to take off and the minimum number of Trip Units for the minimum amount of total fuel allowed onboard the aircraft in order for it to make the next segment and then determine a first difference between the maximum amount of Trip Units and the minimum amount of Trip Units. The computer is then configured to determine a second difference between the maximum total amount of fuel allowed onboard the aircraft that allows the aircraft to take off and the minimum total amount of fuel allowed onboard the aircraft. To determine the rate at which the number of Trip Units increases the computer is configured to determine a ration of the first difference to the second difference.

As shown in FIG. 5, again only three permutations are provided as illustration, but it is clear that the second permutation, where 10 total units are onboard the aircraft 100 before takeoff at Airport A 302, 15 total units are onboard the aircraft before takeoff at Airport B 306, and 15 units are onboard the aircraft before takeoff at Airport C 308, is the lowest cost scenario of those calculated.

From the table 500, it is known that the starting number of units, designated by “START” is 3 units. Under the cheapest scenario, that means 7 units are added at Airport A before takeoff (i.e., 10 Total Units - 3 starting units = 7 units added). With 7 units added, and the cost at Airport A being $1 / unit of fuel, $7 is spent at Airport A. Because the Trip Units from Airport A to Airport B is 6.25, the aircraft will land at Airport B with 3.75 units onboard (e.g., 10 Total Units onboard the aircraft before takeoff at Airport A - 6.25 burned traveling from Airport A to Airport B = 3.75 units remaining). At takeoff at Airport B, 15 Total Units are onboard the aircraft, which means 11.25 units were added at Airport B between landing (from Airport A) and takeoff (e.g., 15 Total Units before takeoff at Airport B - 3.75 units upon landing at Airport B = 11.25 units added at Airport B). With 11.25 units added, and the cost per unit at Airport B being $5 / unit, $56.25 is spent at Airport B. Upon landing at Airport C, the aircraft has 0 units of fuel onboard (Trip Units from Airport B to Airport C is 15, 15 units onboard at takeoff from Airport B) and 15 Total Units before taking off at Airport C. Therefore, 15 units of fuel are added at Airport C at $2 / unit, and therefore $30 is spent at Airport C. The total cost of the trip is $7 + $56.25 + $30, or $93.25.

Once the refueling scenario with the lowest cost is determined a refueling report that indicates the different numbers of units of fuel to add to the aircraft at each of the airports can be generated and at each respective airport, the aircraft 100 is refueled according to the refueling report.

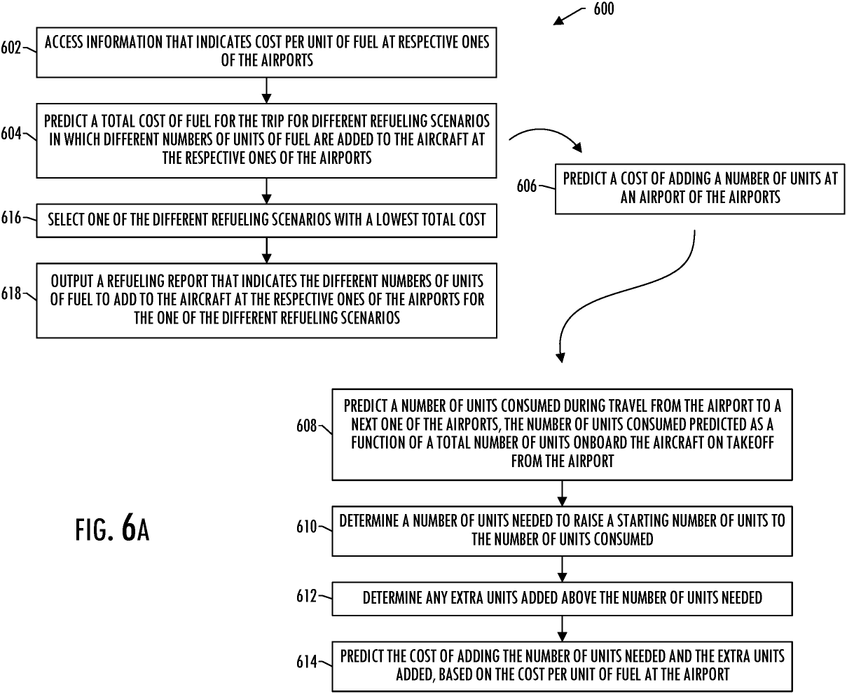

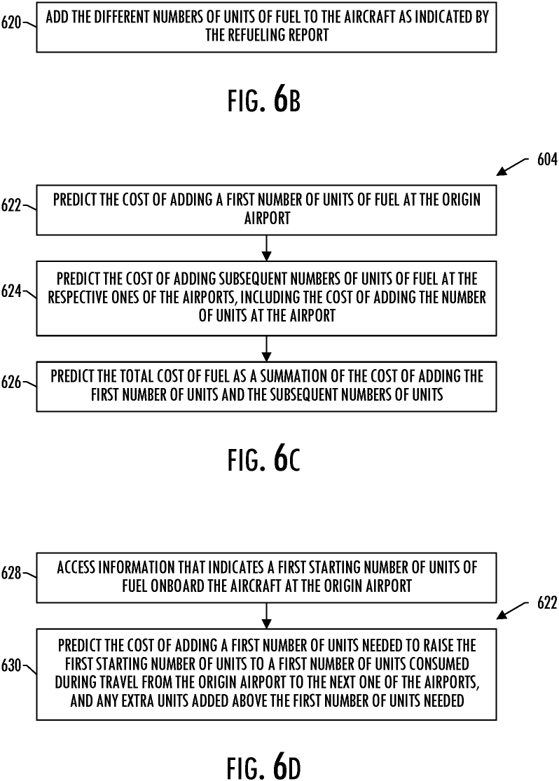

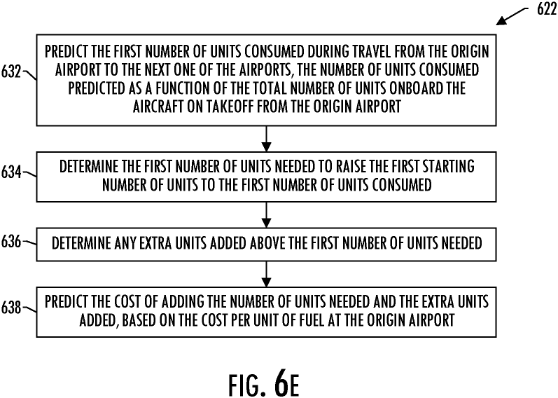

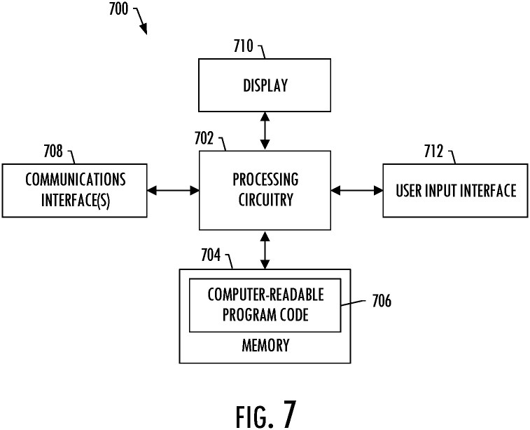

FIGS. 6A - 6E are flowcharts illustrating various steps in a method 600 of refueling an aircraft for a trip that includes multiple flight segments separated by stops at airports with fueling operations, according to various example implementations of the present disclosure. The method includes accessing information that indicates cost per unit of fuel at respective ones of the airports, as shown at block 602 of FIG. 6A. The method includes predicting a total cost of fuel for the trip for different refueling scenarios in which different numbers of units of fuel are added to the aircraft at the respective ones of the airports, as shown at block 604. Predicting the total cost includes predicting a cost of adding a number of units at an airport of the airports, as shown at block 606.

Predicting the cost of adding the number of units at the airport (at block 606) includes predicting a number of units consumed during travel from the airport to a next one of the airports, the number of units consumed predicted as a function of a total number of units onboard the aircraft on takeoff from the airport, as shown at block 608. A number of units needed to raise a starting number of units to the number of units consumed is determined, as shown at block 610. Any extra units added above the number of units needed is determined, as shown at block 612. And the cost of adding the number of units needed and the extra units added is predicted, based on the cost per unit of fuel at the airport, as shown at block 614.

As also shown, the method 600 includes selecting one of the different refueling scenarios with a lowest total cost, as shown at block 616. And the method includes outputting a refueling report that indicates the different numbers of units of fuel to add to the aircraft at the respective ones of the airports for the one of the different refueling scenarios, as shown at block 618.

In some examples, the method 600 further includes adding the different numbers of units of fuel to the aircraft as indicated by the refueling report, as shown at block 620 of FIG. 6B.

In some examples, the trip starts at an origin airport that also has refueling operations, and different numbers of units of fuel are also added to the aircraft at the origin airport in the different refueling scenarios. In some of these examples, predicting the total cost of fuel for a refueling scenario of the different refueling scenarios at block 604 includes predicting the cost of adding a first number of units of fuel at the origin airport, as shown at block 622 of FIG. 6C. Also in some of these examples, the method 600 includes predicting the cost of adding subsequent numbers of units of fuel at the respective ones of the airports, including the cost of adding the number of units at the airport, as shown at block 624. And the method includes predicting the total cost of fuel as a summation of the cost of adding the first number of units and the subsequent numbers of units, as shown at block 626.

In some examples, the method 600 further includes accessing information that indicates a first starting number of units of fuel onboard the aircraft at the origin airport, as shown at block 628 of FIG. 6D. In some of these examples, predicting the cost of adding the first number of units of fuel at block 622 includes predicting the cost of adding a first number of units needed to raise the first starting number of units to a first number of units consumed during travel from the origin airport to the next one of the airports, and any extra units added above the first number of units needed, as shown at block 630.

In some examples, predicting the cost of adding the first number of units at block 622 includes predicting the first number of units consumed during travel from the origin airport to the next one of the airports, the number of units consumed predicted as a function of the total number of units onboard the aircraft on takeoff from the origin airport, as shown at block 632 of FIG. 6E. The method 600 includes determining the first number of units needed to raise the first starting number of units to the first number of units consumed, as shown at block 634. The method includes determining any extra units added above the first number of units needed, as shown at block 636. And the method includes predicting the cost of adding the number of units needed and the extra units added, based on the cost per unit of fuel at the origin airport, as shown at block 638.

In some examples, the function for prediction at block 608 of the number of units consumed is a linear function in which a change in the number of units consumed during travel from the airport is directly proportional to a change in the total number of units onboard the aircraft on takeoff from the airport.

In some examples, the function for prediction at block 608 of the number of units consumed is a function of a weight of the aircraft and a distance from the airport to the next one of the airports, and the weight of the aircraft includes the weight of the total number of units onboard the aircraft, and the weight of any passengers, crew, equipment, luggage and cargo onboard the aircraft on takeoff from the airport.

In some examples, each of the different refueling scenarios includes a different combination of extra units added across the airports.

In some examples, no extra units of fuel are added at one or more of the airports in one or more of the different refueling scenarios.

According to example implementations of the present disclosure, the system 400 and its subsystems, including the computer 402, can be implemented in various manners. Such manners for implementing the system and its subsystems can include hardware, alone or under direction of one or more computer programs from a computer-readable storage medium. In some examples, one or more apparatuses can be configured to function as or otherwise implement the system and its subsystems, including the computer, shown and described herein. In examples involving more than one apparatus, the respective apparatuses can be connected to or otherwise in communication with one another in a number of different manners, such as directly or indirectly via a wired or wireless network or the like.

FIG. 7 illustrates an apparatus 700 according to some example implementations of the present disclosure. Generally, an apparatus of exemplary implementations of the present disclosure can comprise, include or be embodied in one or more fixed or portable electronic devices. Examples of suitable electronic devices include a smartphone, tablet computer, laptop computer, desktop computer, workstation computer, server computer or the like. The apparatus can include one or more of each of a number of components such as, for example, processing circuitry 702 (e.g., processor unit) connected to a memory 704 (e.g., storage device).

In some aspects, the processing circuitry 702 includes one or more processors alone or in combination with one or more memories. The processing circuitry is generally any piece of computer hardware that is capable of processing information such as, for example, data, computer programs and/or other suitable electronic information. The processing circuitry includes a collection of electronic circuits some of which can be packaged as an integrated circuit or multiple interconnected integrated circuits (an integrated circuit at times more commonly referred to as a “chip”). The processing circuitry can be configured to execute computer programs, which can be stored onboard the processing circuitry or otherwise stored in the memory 704 (of the same or another apparatus).

The processing circuitry 702 can be a number of processors, a multi-core processor or some other type of processor, depending on the particular implementation. Further, the processing circuitry can be implemented using a number of heterogeneous processor systems in which a main processor is present with one or more secondary processors on a single chip. As another illustrative example, the processing circuitry can be a symmetric multi-processor system containing multiple processors of the same type. In yet another example, the processing circuitry can be embodied as or otherwise include one or more ASICs, FPGAs or the like. Thus, although the processing circuitry can be capable of executing a computer program to perform one or more functions, the processing circuitry of various examples can be capable of performing one or more functions without the aid of a computer program. In either instance, the processing circuitry can be appropriately programmed to perform functions or operations according to example implementations of the present disclosure.

The memory 704 is generally any piece of computer hardware that is capable of storing information such as, for example, data, computer programs (e.g., computer-readable program code 706) and/or other suitable information either on a temporary basis and/or a permanent basis. The memory can include volatile and/or non-volatile memory, and can be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks can include compact disk - read only memory (CD-ROM), compact disk - read/write (CD-R/W), DVD or the like. In various instances, the memory can be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein can generally refer to a computer-readable storage medium or computer-readable transmission medium.

In addition to the memory 704, the processing circuitry 702 can also be connected to one or more interfaces for displaying, transmitting and/or receiving information. The interfaces can include a communications interface 708 (e.g., communications unit) and/or one or more user interfaces. The communications interface can be configured to transmit and/or receive information, such as to and/or from other apparatus(es), network(s) or the like. The communications interface can be configured to transmit and/or receive information by physical (wired) and/or wireless communications links. Examples of suitable communication interfaces include a network interface controller (NIC), wireless NIC (WNIC) or the like.

The user interfaces can include a display 710 and/or one or more user input interfaces 712 (e.g., input/output unit). The display can be configured to present or otherwise display information to a user, suitable examples of which include a liquid crystal display (LCD), light-emitting diode display (LED), plasma display panel (PDP) or the like. The user input interfaces can be wired or wireless, and can be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces can further include one or more interfaces for communicating with peripherals such as printers, scanners or the like.

As indicated above, program code instructions can be stored in memory, and executed by processing circuitry that is thereby programmed, to implement functions of the systems, subsystems, tools and their respective elements described herein. As will be appreciated, any suitable program code instructions can be loaded onto a computer or other programmable apparatus from a computer-readable storage medium to produce a particular machine, such that the particular machine is configured to implement the functions specified herein. These program code instructions can also be stored in a computer-readable storage medium that can direct a computer, a processing circuitry or other programmable apparatus to function in a particular manner to thereby generate a particular machine or particular article of manufacture. The instructions stored in the computer-readable storage medium can produce an article of manufacture, where the article of manufacture is configured to implement functions described herein. The program code instructions can be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions can be performed sequentially such that one instruction is retrieved, loaded and executed at a time. In some example implementations, retrieval, loading and/or execution can be performed in parallel such that multiple instructions are retrieved, loaded, and/or executed together. Execution of the program code instructions can produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 700 can include a processing circuitry 702 and a computer-readable storage medium or memory 704 coupled to the processing circuitry, where the processing circuitry is configured to execute computer-readable program code 706 stored in the memory. It will also be understood that one or more functions, and combinations of functions, can be implemented by special purpose hardware-based computer systems and/or processing circuitry which perform the specified functions, or combinations of special purpose hardware and program code instructions.

As explained above and reiterated below, the present disclosure includes, without limitation, the following example implementations.

Clause 1. An apparatus for refueling an aircraft for a trip that includes multiple flight segments separated by stops at airports with fueling operations, the apparatus comprising: a memory configured to store computer-readable program code; and processing circuitry configured to access the memory, and execute the computer-readable program code to cause the apparatus to at least: access information that indicates cost per unit of fuel at respective ones of the airports; predict a total cost of fuel for the trip for different refueling scenarios in which different numbers of units of fuel are added to the aircraft at the respective ones of the airports, the apparatus caused to predict the total cost includes the apparatus caused to predict a cost of adding a number of units at an airport of the airports, and the apparatus caused to predict the cost of adding the number of units at the airport includes the apparatus caused to at least: predict a number of units consumed during travel from the airport to a next one of the airports, the number of units consumed predicted as a function of a total number of units onboard the aircraft on takeoff from the airport; determine a number of units needed to raise a starting number of units to the number of units consumed; determine any extra units added above the number of units needed; and predict the cost of adding the number of units needed and the extra units added, based on the cost per unit of fuel at the airport; select one of the different refueling scenarios with a lowest total cost; and output a refueling report that indicates the different numbers of units of fuel to add to the aircraft at the respective ones of the airports for the one of the different refueling scenarios.

Clause 2. The apparatus of clause 1, wherein the trip starts at an origin airport that also has refueling operations, and different numbers of units of fuel are also added to the aircraft at the origin airport in the different refueling scenarios, and wherein the apparatus caused to predict the total cost of fuel for a refueling scenario of the different refueling scenarios includes the apparatus caused to at least: predict the cost of adding a first number of units of fuel at the origin airport; predict the cost of adding subsequent numbers of units of fuel at the respective ones of the airports, including the cost of adding the number of units at the airport; and predict the total cost of fuel as a summation of the cost of adding the first number of units and the subsequent numbers of units.

Clause 3. The apparatus of clause 2, wherein the processing circuitry is configured to execute the computer-readable program code to cause the apparatus to further access information that indicates a first starting number of units of fuel onboard the aircraft at the origin airport, and wherein the apparatus caused to predict the cost of adding the first number of units of fuel includes the apparatus caused to predict the cost of adding a first number of units needed to raise the first starting number of units to a first number of units consumed during travel from the origin airport to the next one of the airports, and any extra units added above the first number of units needed.

Clause 4. The apparatus of clause 3, wherein the apparatus caused to predict the cost of adding the first number of units the apparatus caused to at least: predict the first number of units consumed during travel from the origin airport to the next one of the airports, the number of units consumed predicted as a function of the total number of units onboard the aircraft on takeoff from the origin airport; determine the first number of units needed to raise the first starting number of units to the first number of units consumed; determine any extra units added above the first number of units needed; and predict the cost of adding the number of units needed and the extra units added, based on the cost per unit of fuel at the origin airport.

Clause 5. The apparatus of any of clauses 1 to 4, wherein the function for prediction of the number of units consumed is a linear function in which a change in the number of units consumed during travel from the airport is directly proportional to a change in the total number of units onboard the aircraft on takeoff from the airport.

Clause 6. The apparatus of any of clauses 1 to 5, wherein the function for prediction of the number of units consumed is a function of a weight of the aircraft and a distance from the airport to the next one of the airports, and the weight of the aircraft includes the weight of the total number of units onboard the aircraft, and the weight of any passengers, crew, equipment, luggage and cargo onboard the aircraft on takeoff from the airport.

Clause 7. The apparatus of any of clauses 1 to 6, wherein each of the different refueling scenarios includes a different combination of extra units added across the airports.

Clause 8. The apparatus of any of clauses 1 to 7, wherein no extra units of fuel are added at one or more of the airports in one or more of the different refueling scenarios.

Clause 9. A method of refueling an aircraft for a trip that includes multiple flight segments separated by stops at airports with fueling operations, the method comprising: accessing information that indicates cost per unit of fuel at respective ones of the airports; predicting a total cost of fuel for the trip for different refueling scenarios in which different numbers of units of fuel are added to the aircraft at the respective ones of the airports, predicting the total cost includes predicting a cost of adding a number of units at an airport of the airports, and predicting the cost of adding the number of units at the airport includes: predicting a number of units consumed during travel from the airport to a next one of the airports, the number of units consumed predicted as a function of a total number of units onboard the aircraft on takeoff from the airport; determining a number of units needed to raise a starting number of units to the number of units consumed; determining any extra units added above the number of units needed; and predicting the cost of adding the number of units needed and the extra units added, based on the cost per unit of fuel at the airport; selecting one of the different refueling scenarios with a lowest total cost; and outputting a refueling report that indicates the different numbers of units of fuel to add to the aircraft at the respective ones of the airports for the one of the different refueling scenarios.

Clause 10. The method of clause 9, further comprising adding the different numbers of units of fuel to the aircraft as indicated by the refueling report.

Clause 11. The method of clause 9 or clause 10, wherein the trip starts at an origin airport that also has refueling operations, and different numbers of units of fuel are also added to the aircraft at the origin airport in the different refueling scenarios, and wherein predicting the total cost of fuel for a refueling scenario of the different refueling scenarios includes: predicting the cost of adding a first number of units of fuel at the origin airport; predicting the cost of adding subsequent numbers of units of fuel at the respective ones of the airports, including the cost of adding the number of units at the airport; and predicting the total cost of fuel as a summation of the cost of adding the first number of units and the subsequent numbers of units.

Clause 12. The method of clause 11, wherein the method further comprises accessing information that indicates a first starting number of units of fuel onboard the aircraft at the origin airport, and wherein predicting the cost of adding the first number of units of fuel includes predicting the cost of adding a first number of units needed to raise the first starting number of units to a first number of units consumed during travel from the origin airport to the next one of the airports, and any extra units added above the first number of units needed.

Clause 13. The method of clause 12, wherein predicting the cost of adding the first number of units includes: predicting the first number of units consumed during travel from the origin airport to the next one of the airports, the number of units consumed predicted as a function of the total number of units onboard the aircraft on takeoff from the origin airport; determining the first number of units needed to raise the first starting number of units to the first number of units consumed; determining any extra units added above the first number of units needed; and predicting the cost of adding the number of units needed and the extra units added, based on the cost per unit of fuel at the origin airport.

Clause 14. The method of any of clauses 9 to 13, wherein the function for prediction of the number of units consumed is a linear function in which a change in the number of units consumed during travel from the airport is directly proportional to a change in the total number of units onboard the aircraft on takeoff from the airport.

Clause 15. The method of any of clauses 9 to 14, wherein the function for prediction of the number of units consumed is a function of a weight of the aircraft and a distance from the airport to the next one of the airports, and the weight of the aircraft includes the weight of the total number of units onboard the aircraft, and the weight of any passengers, crew, equipment, luggage and cargo onboard the aircraft on takeoff from the airport.

Clause 16. The method of any of clauses 9 to 15, wherein each of the different refueling scenarios includes a different combination of extra units added across the airports.

Clause 17. The method of any of clauses 9 to 16, wherein no extra units of fuel are added at one or more of the airports in one or more of the different refueling scenarios.

Clause 18. A computer-readable storage medium for refueling an aircraft for a trip that includes multiple flight segments separated by stops at airports with fueling operations, the computer-readable storage medium being non-transitory and having computer-readable program code stored therein that, in response to execution by processing circuitry, causes an apparatus to at least: access information that indicates cost per unit of fuel at respective ones of the airports; predict a total cost of fuel for the trip for different refueling scenarios in which different numbers of units of fuel are added to the aircraft at the respective ones of the airports, the apparatus caused to predict the total cost includes the apparatus caused to predict a cost of adding a number of units at an airport of the airports, and the apparatus caused to predict the cost of adding the number of units at the airport includes the apparatus caused to at least: predict a number of units consumed during travel from the airport to a next one of the airports, the number of units consumed predicted as a function of a total number of units onboard the aircraft on takeoff from the airport; determine a number of units needed to raise a starting number of units to the number of units consumed; determine any extra units added above the number of units needed; and predict the cost of adding the number of units needed and the extra units added, based on the cost per unit of fuel at the airport; select one of the different refueling scenarios with a lowest total cost; and output a refueling report that indicates the different numbers of units of fuel to add to the aircraft at the respective ones of the airports for the one of the different refueling scenarios.

Clause 19. The computer-readable storage medium of clause 18, wherein the trip starts at an origin airport that also has refueling operations, and different numbers of units of fuel are also added to the aircraft at the origin airport in the different refueling scenarios, and wherein the apparatus caused to predict the total cost of fuel for a refueling scenario of the different refueling scenarios includes the apparatus caused to at least: predict the cost of adding a first number of units of fuel at the origin airport; predict the cost of adding subsequent numbers of units of fuel at the respective ones of the airports, including the cost of adding the number of units at the airport; and predict the total cost of fuel as a summation of the cost of adding the first number of units and the subsequent numbers of units.

Clause 20. The computer-readable storage medium of clause 19, wherein the computer-readable storage medium has further computer-readable program code stored therein that, in response to execution by the processing circuitry, causes the apparatus to further access information that indicates a first starting number of units of fuel onboard the aircraft at the origin airport, and wherein the apparatus caused to predict the cost of adding the first number of units of fuel includes the apparatus caused to predict the cost of adding a first number of units needed to raise the first starting number of units to a first number of units consumed during travel from the origin airport to the next one of the airports, and any extra units added above the first number of units needed.

Clause 21. The computer-readable storage medium of clause 20, wherein the apparatus caused to predict the cost of adding the first number of units the apparatus caused to at least: predict the first number of units consumed during travel from the origin airport to the next one of the airports, the number of units consumed predicted as a function of the total number of units onboard the aircraft on takeoff from the origin airport; determine the first number of units needed to raise the first starting number of units to the first number of units consumed; determine any extra units added above the first number of units needed; and predict the cost of adding the number of units needed and the extra units added, based on the cost per unit of fuel at the origin airport.

Clause 22. The computer-readable storage medium of any of clauses 18 to 21, wherein the function for prediction of the number of units consumed is a linear function in which a change in the number of units consumed during travel from the airport is directly proportional to a change in the total number of units onboard the aircraft on takeoff from the airport.

Clause 23. The computer-readable storage medium of any of clauses 18 to 22, wherein the function for prediction of the number of units consumed is a function of a weight of the aircraft and a distance from the airport to the next one of the airports, and the weight of the aircraft includes the weight of the total number of units onboard the aircraft, and the weight of any passengers, crew, equipment, luggage and cargo onboard the aircraft on takeoff from the airport.

Clause 24. The computer-readable storage medium of any of clauses 18 to 23, wherein each of the different refueling scenarios includes a different combination of extra units added across the airports.

Clause 25. The computer-readable storage medium of any of clauses 18 to 24, wherein no extra units of fuel are added at one or more of the airports in one or more of the different refueling scenarios.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions can be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for refueling an aircraft for a trip that includes multiple flight segments separated by stops at airports with fueling operations, the apparatus comprising:
a memory configured to store computer-readable program code; and
processing circuitry configured to access the memory, and execute the computer-readable program code to cause the apparatus to at least:
access information that indicates cost per unit of fuel at respective ones of the airports;
predict a total cost of fuel for the trip for different refueling scenarios in which different numbers of units of fuel are added to the aircraft at the respective ones of the airports, the apparatus caused to predict the total cost includes the apparatus caused to predict a cost of adding a number of units at an airport of the airports, and the apparatus caused to predict the cost of adding the number of units at the airport includes the apparatus caused to at least:
predict a number of units consumed during travel from the airport to a next one of the airports, the number of units consumed predicted as a function of a total number of units onboard the aircraft on takeoff from the airport;
determine a number of units needed to raise a starting number of units to the number of units consumed;
determine any extra units added above the number of units needed; and
predict the cost of adding the number of units needed and the extra units added, based on the cost per unit of fuel at the airport;
select one of the different refueling scenarios with a lowest total cost; and
output a refueling report that indicates the different numbers of units of fuel to add to the aircraft at the respective ones of the airports for the one of the different refueling scenarios.

2. The apparatus of claim 1, wherein the trip starts at an origin airport that also has refueling operations, and different numbers of units of fuel are also added to the aircraft at the origin airport in the different refueling scenarios, and
wherein the apparatus caused to predict the total cost of fuel for a refueling scenario of the different refueling scenarios includes the apparatus caused to at least:
predict the cost of adding a first number of units of fuel at the origin airport;
predict the cost of adding subsequent numbers of units of fuel at the respective ones of the airports, including the cost of adding the number of units at the airport; and
predict the total cost of fuel as a summation of the cost of adding the first number of units and the subsequent numbers of units.

3. The apparatus of claim 2, wherein the processing circuitry is configured to execute the computer-readable program code to cause the apparatus to further access information that indicates a first starting number of units of fuel onboard the aircraft at the origin airport, and
wherein the apparatus caused to predict the cost of adding the first number of units of fuel includes the apparatus caused to predict the cost of adding a first number of units needed to raise the first starting number of units to a first number of units consumed during travel from the origin airport to the next one of the airports, and any extra units added above the first number of units needed.

4. The apparatus of claim 3, wherein the apparatus caused to predict the cost of adding the first number of units includes the apparatus caused to at least:
predict the first number of units consumed during travel from the origin airport to the next one of the airports, the number of units consumed predicted as a function of the total number of units onboard the aircraft on takeoff from the origin airport;
determine the first number of units needed to raise the first starting number of units to the first number of units consumed;
determine any extra units added above the first number of units needed; and
predict the cost of adding the number of units needed and the extra units added, based on the cost per unit of fuel at the origin airport.

5. The apparatus of claim 1, wherein the function for prediction of the number of units consumed is a linear function in which a change in the number of units consumed during travel from the airport is directly proportional to a change in the total number of units onboard the aircraft on takeoff from the airport.

6. The apparatus of claim 1, wherein the function for prediction of the number of units consumed is a function of a weight of the aircraft and a distance from the airport to the next one of the airports, and the weight of the aircraft includes the weight of the total number of units onboard the aircraft, and the weight of any passengers, crew, equipment, luggage and cargo onboard the aircraft on takeoff from the airport.

7. A method of refueling an aircraft for a trip that includes multiple flight segments separated by stops at airports with fueling operations, the method comprising:
accessing information that indicates cost per unit of fuel at respective ones of the airports;
predicting a total cost of fuel for the trip for different refueling scenarios in which different numbers of units of fuel are added to the aircraft at the respective ones of the airports, predicting the total cost includes predicting a cost of adding a number of units at an airport of the airports, and predicting the cost of adding the number of units at the airport includes:
predicting a number of units consumed during travel from the airport to a next one of the airports, the number of units consumed predicted as a function of a total number of units onboard the aircraft on takeoff from the airport;
determining a number of units needed to raise a starting number of units to the number of units consumed;
determining any extra units added above the number of units needed; and
predicting the cost of adding the number of units needed and the extra units added, based on the cost per unit of fuel at the airport;
selecting one of the different refueling scenarios with a lowest total cost; and
outputting a refueling report that indicates the different numbers of units of fuel to add to the aircraft at the respective ones of the airports for the one of the different refueling scenarios.

8. The method of claim 7, further comprising adding the different numbers of units of fuel to the aircraft as indicated by the refueling report.

9. The method of claim 7, wherein the trip starts at an origin airport that also has refueling operations, and different numbers of units of fuel are also added to the aircraft at the origin airport in the different refueling scenarios, and
wherein predicting the total cost of fuel for a refueling scenario of the different refueling scenarios includes:
predicting the cost of adding a first number of units of fuel at the origin airport;
predicting the cost of adding subsequent numbers of units of fuel at the respective ones of the airports, including the cost of adding the number of units at the airport; and
predicting the total cost of fuel as a summation of the cost of adding the first number of units and the subsequent numbers of units.

10. The method of claim 9, wherein the method further comprises accessing information that indicates a first starting number of units of fuel onboard the aircraft at the origin airport, and
wherein predicting the cost of adding the first number of units of fuel includes predicting the cost of adding a first number of units needed to raise the first starting number of units to a first number of units consumed during travel from the origin airport to the next one of the airports, and any extra units added above the first number of units needed.

11. The method of claim 10, wherein predicting the cost of adding the first number of units includes:
predicting the first number of units consumed during travel from the origin airport to the next one of the airports, the number of units consumed predicted as a function of the total number of units onboard the aircraft on takeoff from the origin airport;
determining the first number of units needed to raise the first starting number of units to the first number of units consumed;
determining any extra units added above the first number of units needed; and
predicting the cost of adding the number of units needed and the extra units added, based on the cost per unit of fuel at the origin airport.

12. The method of claim 7, wherein the function for prediction of the number of units consumed is a linear function in which a change in the number of units consumed during travel from the airport is directly proportional to a change in the total number of units onboard the aircraft on takeoff from the airport.

13. The method of claim 7, wherein the function for prediction of the number of units consumed is a function of a weight of the aircraft and a distance from the airport to the next one of the airports, and the weight of the aircraft includes the weight of the total number of units onboard the aircraft, and the weight of any passengers, crew, equipment, luggage and cargo onboard the aircraft on takeoff from the airport.

14. The method of claim 7, wherein each of the different refueling scenarios includes a different combination of extra units added across the airports.

15. A computer-readable storage medium for refueling an aircraft for a trip that includes multiple flight segments separated by stops at airports with fueling operations, the computer-readable storage medium being non-transitory and having computer-readable program code stored therein that, in response to execution by processing circuitry, causes an apparatus to at least:
access information that indicates cost per unit of fuel at respective ones of the airports;
predict a total cost of fuel for the trip for different refueling scenarios in which different numbers of units of fuel are added to the aircraft at the respective ones of the airports, the apparatus caused to predict the total cost includes the apparatus caused to predict a cost of adding a number of units at an airport of the airports, and the apparatus caused to predict the cost of adding the number of units at the airport includes the apparatus caused to at least:
predict a number of units consumed during travel from the airport to a next one of the airports, the number of units consumed predicted as a function of a total number of units onboard the aircraft on takeoff from the airport;
determine a number of units needed to raise a starting number of units to the number of units consumed;
determine any extra units added above the number of units needed; and
predict the cost of adding the number of units needed and the extra units added, based on the cost per unit of fuel at the airport;
select one of the different refueling scenarios with a lowest total cost; and
output a refueling report that indicates the different numbers of units of fuel to add to the aircraft at the respective ones of the airports for the one of the different refueling scenarios.

16. The computer-readable storage medium of claim 15, wherein the trip starts at an origin airport that also has refueling operations, and different numbers of units of fuel are also added to the aircraft at the origin airport in the different refueling scenarios, and
wherein the apparatus caused to predict the total cost of fuel for a refueling scenario of the different refueling scenarios includes the apparatus caused to at least:
predict the cost of adding a first number of units of fuel at the origin airport;
predict the cost of adding subsequent numbers of units of fuel at the respective ones of the airports, including the cost of adding the number of units at the airport; and
predict the total cost of fuel as a summation of the cost of adding the first number of units and the subsequent numbers of units.

17. The computer-readable storage medium of claim 16, wherein the computer-readable storage medium has further computer-readable program code stored therein that, in response to execution by the processing circuitry, causes the apparatus to further access information that indicates a first starting number of units of fuel onboard the aircraft at the origin airport, and
wherein the apparatus caused to predict the cost of adding the first number of units of fuel includes the apparatus caused to predict the cost of adding a first number of units needed to raise the first starting number of units to a first number of units consumed during travel from the origin airport to the next one of the airports, and any extra units added above the first number of units needed.

18. The computer-readable storage medium of claim 17, wherein the apparatus caused to predict the cost of adding the first number of units includes the apparatus caused to at least:
predict the first number of units consumed during travel from the origin airport to the next one of the airports, the number of units consumed predicted as a function of the total number of units onboard the aircraft on takeoff from the origin airport;
determine the first number of units needed to raise the first starting number of units to the first number of units consumed;
determine any extra units added above the first number of units needed; and
predict the cost of adding the number of units needed and the extra units added, based on the cost per unit of fuel at the origin airport.

19. The computer-readable storage medium of claim 15, wherein the function for prediction of the number of units consumed is a linear function in which a change in the number of units consumed during travel from the airport is directly proportional to a change in the total number of units onboard the aircraft on takeoff from the airport.

20. The computer-readable storage medium of claim 15, wherein the function for prediction of the number of units consumed is a function of a weight of the aircraft and a distance from the airport to the next one of the airports, and the weight of the aircraft includes the weight of the total number of units onboard the aircraft, and the weight of any passengers, crew, equipment, luggage and cargo onboard the aircraft on takeoff from the airport.
